(19) United States
(12) Patent Application Publication
(10) Pub. No.: US 2010/0127643 A1
(43) Pub. Date: May 27, 2010

(54) IMAGE DISPLAY APPARATUS

(75) Inventor: Tomoya Onishi, Ayase-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/622,316

(22) Filed: Nov. 19, 2009

(30) Foreign Application Priority Data
Nov. 21, 2008 (JP) 2008-298179

(51) Int. Cl. H01J 17/36

(52) U.S. Cl. 315/326

(57) ABSTRACT

An image display apparatus includes a rear plate including electron-emitting devices, a face plate including an anode electrode for accelerating electrons from the electron-emitting devices, a plate-shaped spacer being disposed between the rear and face plates and including a conductive member formed in a longitudinal direction of the spacer, and a potential-supplying unit for forming a potential gradient in the conductive member in the longitudinal direction of the spacer to compensate a difference between a distance to the spacer from a position on the face plate irradiated with electrons emitted from a first electron-emitting device among the electron-emitting devices and that from a position on the face plate irradiated with electrons emitted from a second electron-emitting device among the electron-emitting devices, the second electron-emitting device being located at a position shifted in the longitudinal direction of the spacer with respect to a position of the first electron-emitting device.

### BACKGROUND OF THE INVENTION

1. Field of the Invention

The present invention generally relates to image display apparatuses. In particular, it relates to an image display apparatus that includes an electron-emitting device and a spacer.

2. Description of the Related Art

Field emission displays (FEDs) that use electron-emitting devices are a well known type of flat image display apparatuses. In a typical field emission display, a spacer is provided between a rear plate equipped with electron-emitting devices and a face plate equipped with a fluorescent member.

It has been known that when a spacer in a field emission display is charged, the trajectory of an electron emitted from an electron-emitting device becomes deflected (refer to Japanese Patent Laid-Open No. 2003-029697). When the degree to which the electron trajectory is deflected differs between a region near the spacer (also referred to as “near spacer region” hereinafter) and a region not near the spacer (also referred to as “distant region” hereinafter), the spacer becomes visually recognizable. This is not desirable for any image display apparatus.

Another example of a typical structure known in the art is to form an electrode on a side wall of a spacer and to supply an electrical potential to the electrode (refer to Japanese Patent No. 3340440).

### SUMMARY OF THE INVENTION

The inventors of the present invention have found that when a plate-shaped spacer is used, a distribution occurs in the longitudinal direction of the spacer in terms of the deflection direction of electron trajectories and the degree of deflection.

Thus, it is desirable to suppress positions on a face plate irradiated with electrons emitted from electron-emitting devices from varying in the longitudinal direction of the spacer.

An aspect of the present invention provides an image display apparatus including a rear plate including a plurality of electron-emitting devices, a face plate including an anode electrode configured to accelerate electrons emitted from the plurality of electron-emitting devices, a spacer which is a plate-shaped spacer disposed between the rear plate and the face plate, the spacer including a conductive member formed in a longitudinal direction of the spacer, and a potential-supplying unit configured to form a potential gradient in the conductive member in the longitudinal direction of the spacer so as to compensate a difference between a distance to the spacer from a position on the face plate irradiated with electrons emitted from a first electron-emitting device among the plurality of electron-emitting devices and a distance to the spacer from a position on the face plate irradiated with electrons emitted from a second electron-emitting device among the plurality of electron-emitting devices, the second electron-emitting device being located at a position shifted in the longitudinal direction of the spacer with respect to a position of the first electron-emitting device.

According to such an image display apparatus, positions on a face plate irradiated with electrons emitted from electron-emitting devices can be suppressed from varying in the longitudinal direction of the spacer.

Further features of the present invention will become apparent from the following description of exemplary embodiments with reference to the attached drawings.

### BRIEF DESCRIPTION OF THE DRAWINGS

FIG. 1 is a perspective view of an example structure of an image display apparatus.

FIG. 2 is a cross-sectional view of the image display apparatus near a spacer.

FIGS. 3A and 3B are diagrams showing a potential distribution in a conductive member.

FIG. 4 is a diagram showing a potential distribution near a spacer.

FIG. 5 is another diagram showing a potential distribution near a spacer.

FIG. 6 is a diagram showing electron-irradiated positions in an image display region.

FIG. 7 is a diagram showing a potential distribution in a conductive member according to a first embodiment.

FIG. 8 is a cross-sectional view of an image display apparatus near a spacer.

FIGS. 9A and 9B are diagrams showing a potential distribution in a conductive member.

FIG. 10 is a diagram illustrating a step of forming a conductive member.

### DESCRIPTION OF THE EMBODIMENTS

### First Embodiment

Embodiments of the present invention will now be described with reference to drawings.

An image display apparatus of a first embodiment is of a type that displays images by electron irradiation. The apparatus includes electron-emitting devices such as field emission devices, metal-insulator-metal (MIM) devices, or surface-conduction electron-emitting devices. The first embodiment will now be described in detail by using as an example an image display apparatus that includes surface-conduction electron-emitting devices.

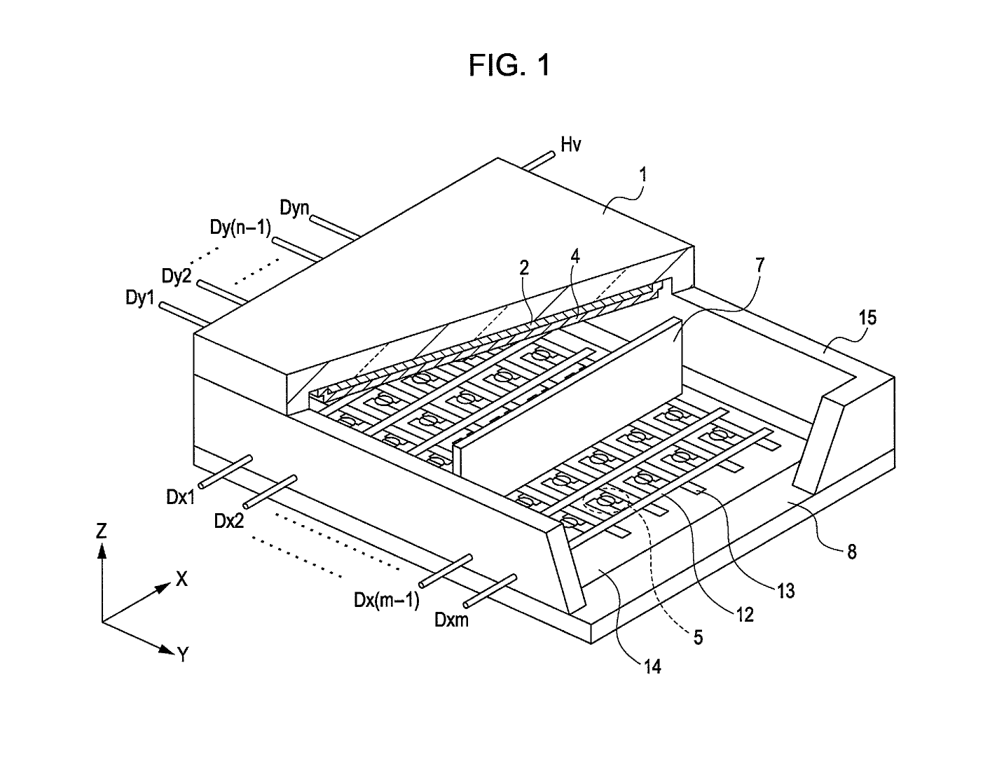

FIG. 1 is a perspective view of an example structure of an image display apparatus of this embodiment, part of which is cut away to show its internal structure.

A rear plate used in the image display apparatus of this embodiment is first described. A scan wiring 12, a modulation wiring 13, and an electron source substrate 14 that includes an insulating interlayer (not shown) for insulating the scan wiring 12 from the modulation wiring 13 and a plurality of electron-emitting devices 5 are affixed on a rear plate 8. The electron source substrate 14 may also serve as the rear plate 8.

Each of the electron-emitting devices 5 is a surface-conduction electron-emitting device in which a conductive film with an electron emitting portion is connected between a pair of device electrodes. N×M electron-emitting devices 5 are arranged and connected into a matrix through M scan wirings 12 and N modulation wirings 13 arranged at regular intervals. The scan wirings 12 are located above the modulation wirings 13 with the insulating interlayer therebetween. Scan signals are supplied to the scan wirings 12 through extraction terminals Dx1 to Dxm, and modulation signals are supplied to the modulation wirings 13 through extraction terminals Dy1 to Dyn.

A face plate used in the image display apparatus of this embodiment will now be described.

A light-transmitting substrate, i.e., a glass substrate, is used as a substrate for a face plate 1. Fluorescent members 2 that emit light when irradiated with electrons are disposed on an inner surface of the face plate 1. In this embodiment, three fluorescent members of three colors, namely, red, blue, and green, are provided. A stripe-shaped or matrix-shaped black member (not shown) is disposed between the fluorescent members.

A typical metal back 4 used in the field of cathode ray tubes (CRTs) is disposed on the rear plate-side surface of the fluorescent member. An acceleration voltage for accelerating the electrons emitted from the electron-emitting devices 5 is applied to the metal back 4 via a high-voltage terminal Hv. In other words, the metal back 4 functions as an anode electrode for accelerating the electrons emitted from the electron-emitting devices 5.

Next, a spacer 7 is described. The interior of an image display panel of an image display apparatus that uses electron-emitting devices needs to be vacuumed. Thus, the face plate 1 and the rear plate 8 are put under an atmospheric pressure. A spacer 7 is thereby required between the face plate 1 and the rear plate 8. Moreover, since the spacer 7 is disposed between the face plate 1 and the rear plate 8 to which a high voltage is applied, the spacer 7 must have a withstand voltage.

The spacer 7 is desirably of a type that can reduce the difference in potential distribution between near spacer regions and distant regions. This is because if the difference in potential distribution between the near spacer regions and the distant regions is large, the trajectories of electrons will differ between the near spacer regions and the distant regions, resulting in deterioration of image quality. In particular, when the spacer becomes charged as a result of electron irradiation, the potential distribution undergoes changes. Resistance can be imparted to the spacer 7 to moderate charging of the spacer 7. Examples of the ways to impart resistance to the spacer 7 include imparting electrical conductivity to a spacer base member and forming a high-resistance film on the surface of a spacer base member composed of glass.

An example of imparting electrical conductivity to the spacer base member involves use of an electric resistance ceramic composition formed by bonding a transition metal oxide (e.g., iron oxide, titanium dioxide, chromium(III) oxide, vanadium oxide, or nickel oxide) to an electrically insulating ceramic (such as alumina). When the transition metal oxide is bonded to alumina, a ceramic having an electrical resistivity of a desired range, i.e., 10⁶ to 10¹⁵ Ωcm, can be obtained.

In the case of forming a high-resistance film on the surface of the spacer base member, one of the functions required for the high-resistance film is that it allows a minute electric current that moderates the charging as mentioned above to flow. If the resistance is too low, too much current flows, power consumption increases, and the temperature at that portion increases. This is not desirable. In contrast, if the resistance is too high, the minute electric current that moderates the charging does not flow. Thus, the resistance of the high-resistance film can be 10⁷ to 10¹⁶Ω/□ in terms of sheet resistance.

Examples of the material for the high resistance film include metal oxides. Among metal oxides, oxides of chromium, nickel, and copper may be used since these oxides have a relatively low secondary electron emission efficiency and are not easily chargeable. Aside from the metal oxides, carbon may also be used since it has a low secondary electron emission efficiency.

Other examples of the material for the high-resistance film include nitrides of alloys of germanium and transition metals. Such nitrides can be used since their resistance can be controlled over a wide range from a good conductor to an insulator by adjusting the composition of the transition metals. Examples of the transition metal elements include Ti, V, Cr, Mn, Fe, Co, Ni, Cu, Zr, Nb, Mo, Hf, and W.

The nitrides are formed on a spacer substrate by a thin-film forming technique such as sputtering, reactive sputtering in a nitrogen gas atmosphere, electron beam evaporation, ion plating, or an ion-assisted vapor deposition. The metal oxide films can be formed by the same thin-film forming technique but with oxygen gas instead of nitrogen gas. The metal oxide films can be formed by chemical vapor deposition (CVD), an alkoxide application technique, or the like. When a carbon film is to be used, vapor deposition, sputtering, CVD, or plasma CVD is employed to form the carbon film. In particular, in making amorphous carbon, either hydrogen should be contained in the atmosphere during film forming or hydrocarbon gas should be used as the deposition gas.

The spacer 7 of this embodiment extends along the scan wiring 12. The present invention is also applicable to the cases in which the spacer 7 is arranged to extend along the modulation wiring 13.

The rear plate 8 and the face plate 1 are attached to a supporting frame 15 with glass frit or the like.

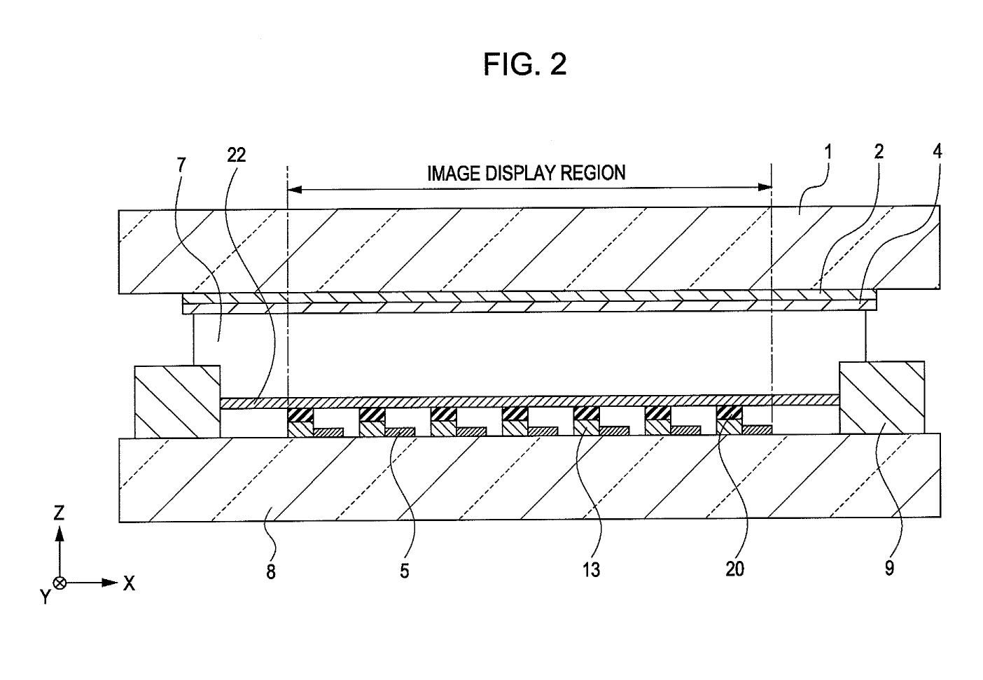

FIG. 2 is a cross-sectional view taken in the X direction near the spacer in FIG. 1. The components identical to those illustrated in FIG. 1 are represented by the same reference numerals and description therefor is omitted to avoid redundancy.

In this embodiment, the spacer 7 is formed so that the longitudinal direction of the spacer 7 is the X direction in which the scan wiring 12 extends. The length of the spacer 7 in the longitudinal direction is larger than the length of an image display region of the image display apparatus in the X direction. The spacer 7 extends across the image display region in the longitudinal direction. This is because the spacer 7 typically has a high aspect ratio shape with a height of several millimeters in the Z direction, a length of several to several thousands millimeters in the X direction, and a thickness of several ten to several hundreds micrometers in the Y direction, and thus requires a fixing member 9 for fixing the spacer. When the fixing member 9 is located within the image display region, it affects the electron trajectories. Thus, the fixing member 9 may be provided outside the image display region. This causes the spacer 7 to extend across the image display region in the longitudinal direction. Note that the “image display region” refers to a region of the image display apparatus where images are displayed.

Next, a conductive member 22 that extends along the spacer 7 in the longitudinal direction is described. The conductive member 22 is formed to define the potential distribution of the spacer 7. In order to define the potential, the resistance of the conductive member 22 must be lower than that of the spacer 7 having resistance. The conductive member 22 is usually formed of a metal film or a metal oxide film. In the case where the resistance does not have to be adjusted, metal materials such as Pt, Au, Al, W, and Cu can be used. In the case where the resistance must be adjusted, nitrides of alloys of germanium and transition metals and metal oxides can be used. Examples of the method for forming the conductive member 22 include thin film-forming techniques such as sputtering, reactive sputtering in a nitrogen atmosphere, electron beam evaporation, ion plating, and ion-assisted vapor deposition, and an alkoxide application technique. Since patterning is needed, the conductive member 22 may be formed by mask vapor deposition, photolithography, screen-printing, ink jet technique, of the like.

In this embodiment, since the conductive member 22 is formed on a surface of the spacer 7 facing the rear plate 8, an insulating layer 20 for insulating between the conductive member 22 and the wirings is provided. Although the scan wirings 12 above the modulation wirings 13 are not depicted, the insulating layer 20 is also formed between the conductive member 22 and the scan wirings 12. The insulating layer 20 is, for example, an insulating film composed of a ceramic such as glass frit or alumina, or SiO₂, and is made by photolithography, printing, or the like.

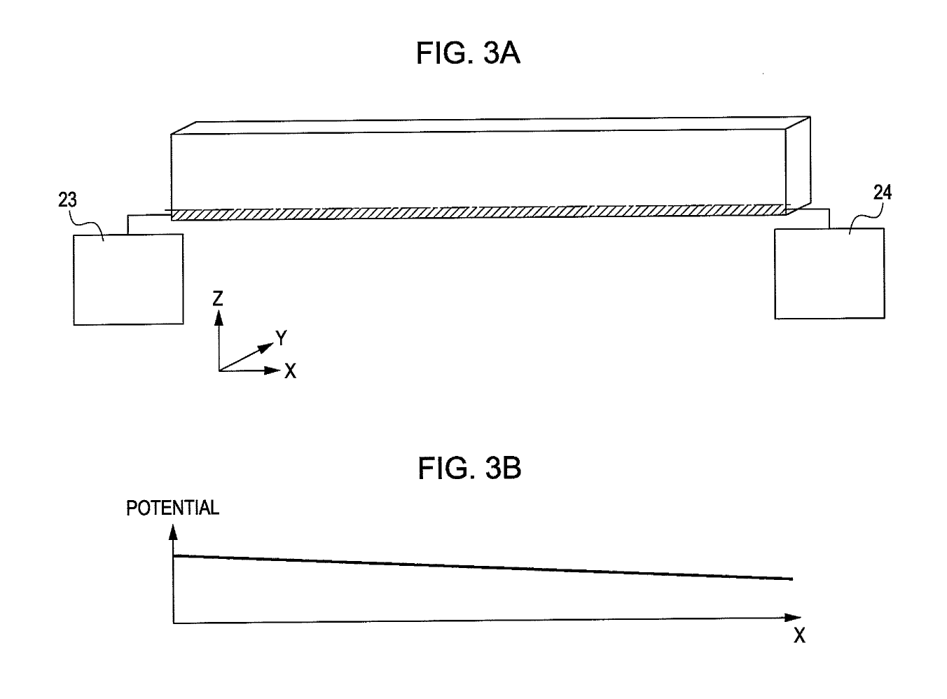

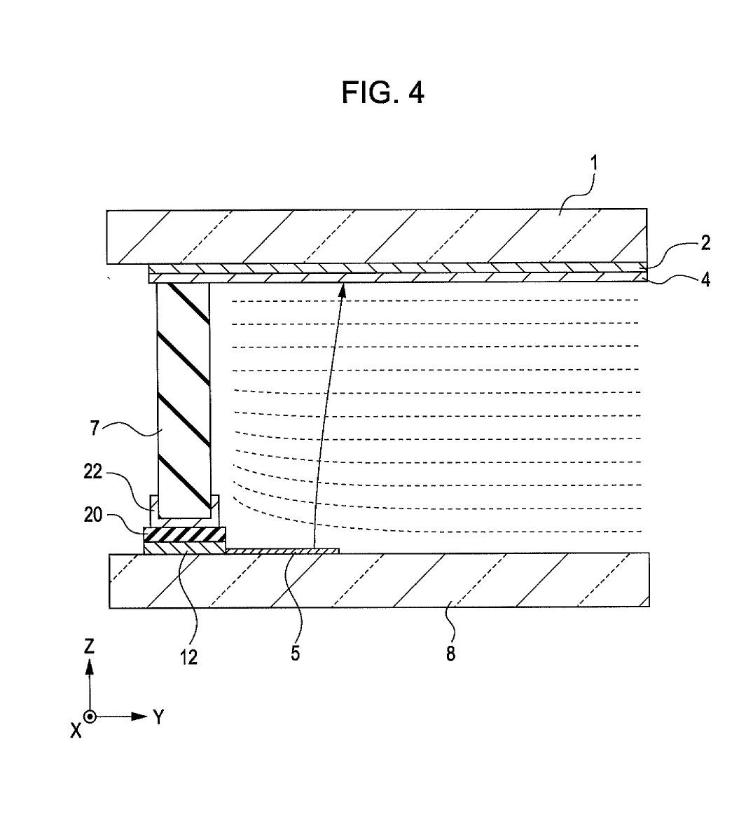

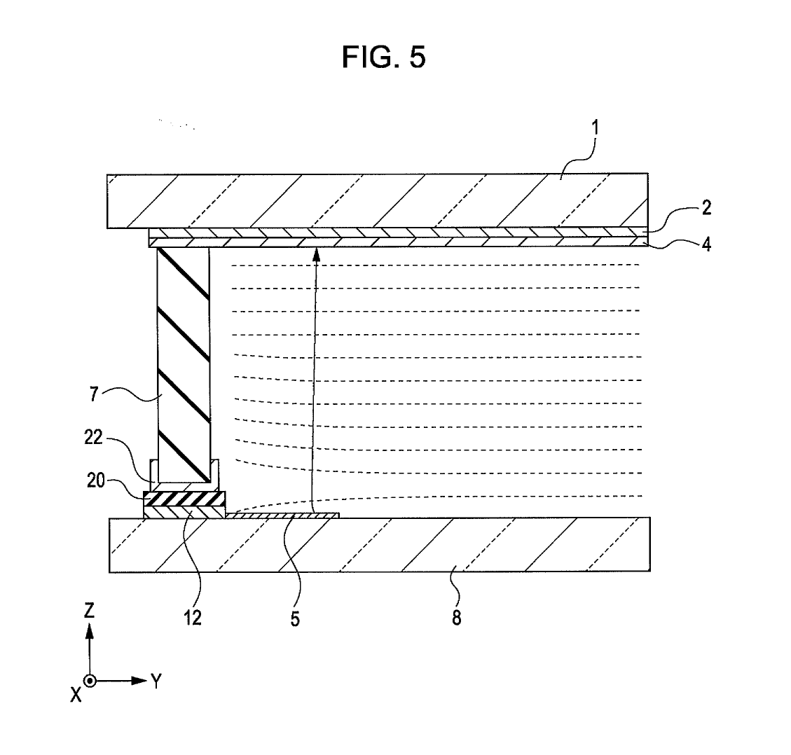

As shown in FIG. 3A, two ends of the conductive member 22 are respectively connected to potential supplying units 23 and 24. In this embodiment, the potential supplying unit 23 provides a higher potential than the potential supplying unit 24. Thus, a potential gradient shown in FIG. 3B is formed in the conductive member 22. In other words, according to this embodiment, a potential gradient can be formed in the longitudinal direction of the spacer 7. The advantages of forming the potential gradient in the longitudinal direction of the spacer 7 are described below with reference to FIGS. 4 and 5.

FIGS. 4 and 5 are diagrams illustrating potential distributions near the spacer 7. Broken lines in the drawings represent equipotential lines.

FIG. 4 is a diagram showing equipotential lines of the case where the potential of the conductive member 22 is close to that of the electron-emitting device 5. In this case, the equipotential lines are generally lifted in the Z direction and, as shown in FIG. 4, and the trajectory of electrons deflects away from the spacer 7 as shown in FIG. 4. When a higher potential is applied from the conductive member 22, as shown in FIG. 5, a position directly above the electron-emitting device 5 is irradiated with electrons depending on the applied potential.

Accordingly, the position on the face plate 1 to be irradiated with electrons can be adjusted by controlling the potential of the conductive member 22.

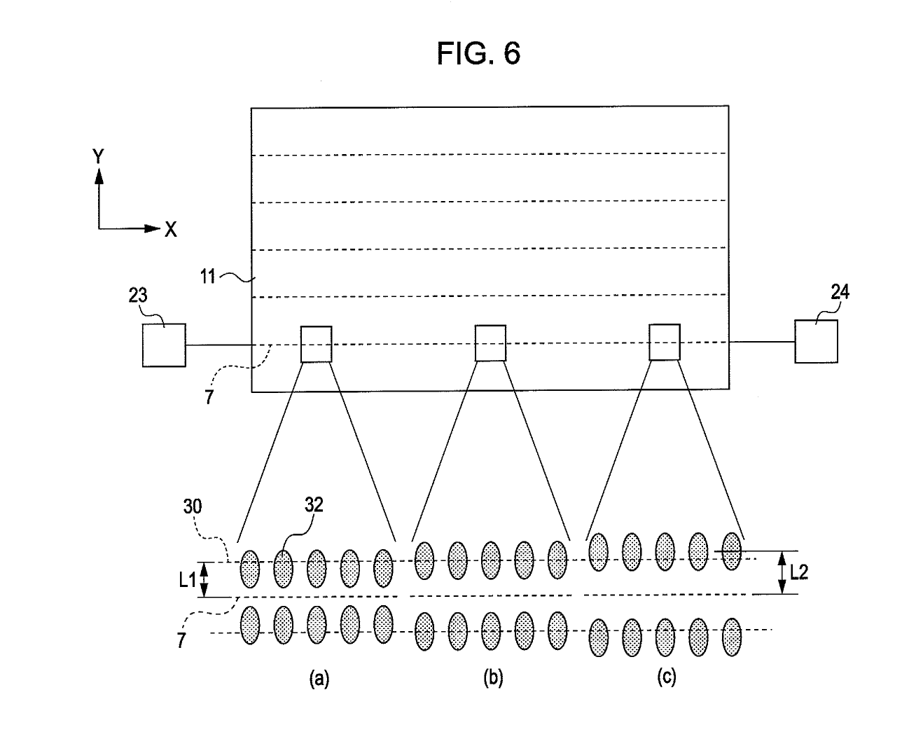

Next, in this embodiment, a specific process for suppressing the positions of the face plate to be irradiated with electrons emitted from the electron-emitting devices from varying in the longitudinal direction of the spacer is described with reference to FIG. 6.

FIG. 6 is a diagram showing positions irradiated with electrons within the image display region. In the drawing, reference numeral 11 denotes an image display region. Reference numeral 7 represents a spacer. In parts (a), (b), and (c) of FIG. 6, the positions irradiated with electrons at the left side, the center, and the right side of the image display region are respectively shown in enlarged views. Broken lines 30 indicate the position to be irradiated with electrons when no spacer is provided (hereinafter this position is referred to as “normal electron-irradiated position”). The actual positions irradiated with electrons are positions 32. In part (a), the actual electron-irradiated positions 32 are shifted toward the spacer 7 with respect to the normal electron-irradiated position 30. In part (c), the actual electron-irradiated positions 32 are shifted away from the spacer 7 with respect to the normal electron-irradiated position 30. The state shown in part (b) is between the state shown in part (a) and the state shown in part (c). In part (b), the normal electron-irradiated position 30 is close to the actual electron-irradiated positions 32. The reason why the actual electron-irradiated positions 32 have a distribution in the longitudinal direction of the spacer 7 is not clear. However, the inventors have found that there are cases in which the actual electron-irradiated positions 32 have a distribution in the longitudinal direction of the spacer 7.

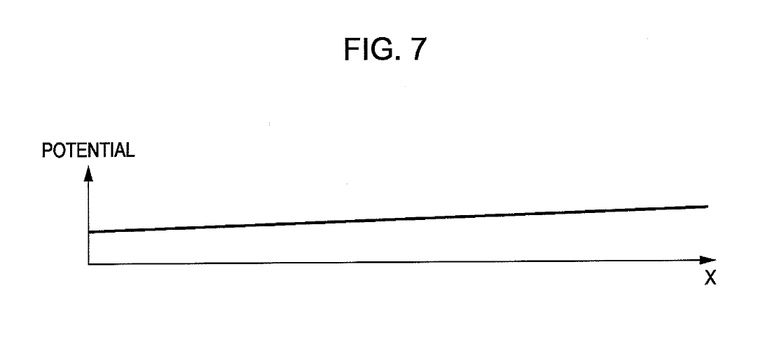

In this embodiment, as described with reference to FIGS. 4 and 5, the trajectory of the electrons emitted from the electron-emitting device becomes closer to the spacer 7 as the potential applied to the conductive member 22 increases. Thus, as shown in FIG. 7, when a potential is applied to the conductive member 22 from the potential supplying units 23 and 24 so that the potential gradient monotonically increasing in the X direction is applied to the conductive member 22, variation of the electron-irradiated positions can be suppressed. Suppose that the distance to the spacer 7 from the position on a face plate irradiated with electrons emitted from an electron-emitting device (referred to as “first electron-emitting device” hereinafter) positioned at part (a) of FIG. 6 is given as L1. Also suppose that the distance to the spacer 7 from the position on the face plate irradiated with electrons emitted from an electron-emitting device (referred to as “second electron-emitting device” hereinafter) located at a position shown in part (c) of FIG. 6 away from the first electron-emitting device in the X direction (longitudinal direction of the spacer 7) is given as L2. In this embodiment, the potential supplying units 23 and 24 supply potential to the conductive member 22 so that the conductive member 22 is given an electrical gradient in which the difference between L1 and L2 is reduced by compensating the difference between L1 and L2. Accordingly, the magnitude of the potential gradient encompassed by the present invention has a certain breadth.

In this embodiment, since the conductive member 22 is formed on the surface of the spacer 7 facing the rear plate 8, the potential applied to the conductive member 22 can be lowered.

### Second Embodiment

A second embodiment of the present invention will now be described.

The second embodiment differs from the first embodiment in that whereas the scan wirings 12 are located above the modulation wirings 13 with the insulating interlayer therebetween in the first embodiment, the modulation wirings 13 of the second embodiment are located above the scan wirings 12 with the insulating interlayer therebetween. Moreover, the structure of the conductive member 22 formed on the spacer 7 is different from that of the first embodiment.

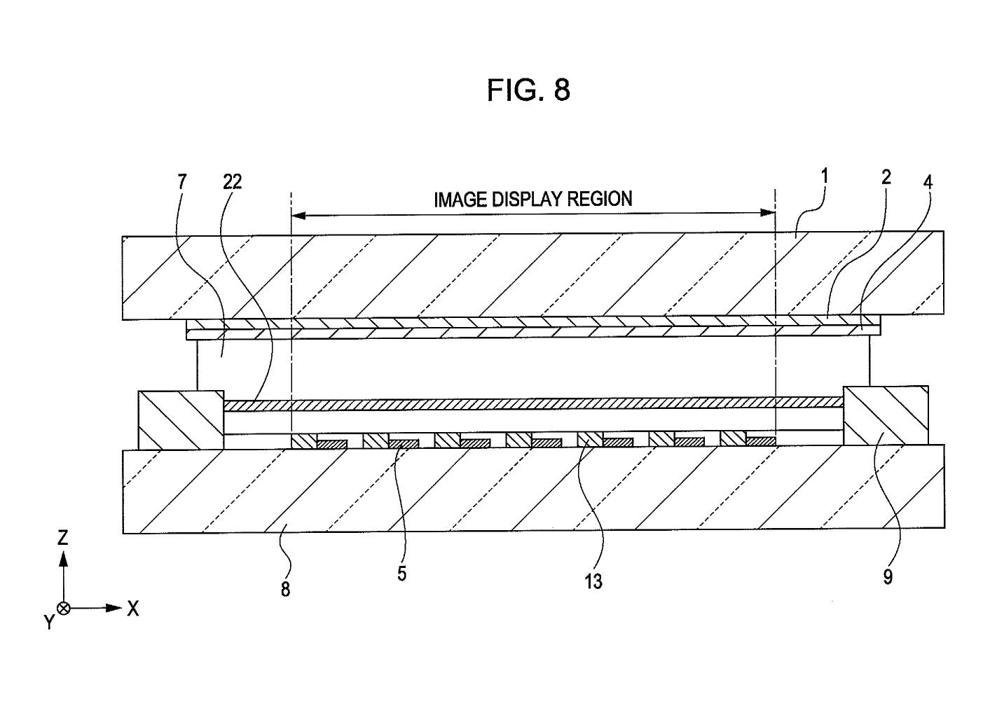

The structure of the conductive member 22 of the second embodiment is shown in FIG. 8. In the first embodiment, the conductive member 22 is formed on the surface of the spacer 7 facing the rear plate 8. The conductive member 22 of the second embodiment is shifted in the Z direction with respect to the conductive member 22 of the first embodiment and is formed on the side surface of the spacer 7. Thus, in the second embodiment, the insulating layer 20 for insulating between the conductive member 22 and the wirings is not needed. This is because the insulation between the conductive member 22 and the wirings can be ensured by the spacer 7 having a sufficiently high resistance. Accordingly, the spacer 7 is directly disposed on the modulation wirings 13.

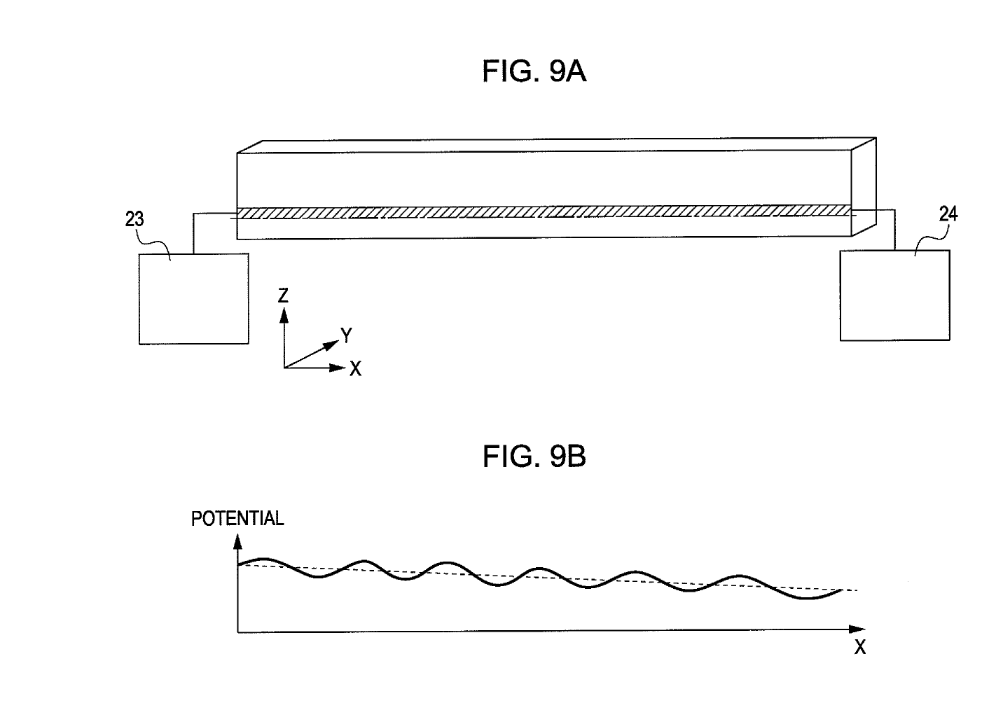

As shown in FIG. 9A, two ends of the conductive member 22 are respectively connected to the potential supplying units 23 and 24. In this embodiment, the potential supplying unit 23 provides a higher potential than the potential supplying unit 24. Thus, a potential gradient shown in FIG. 9B is formed in the conductive member 22. Unlike the first embodiment, the periodically arranged modulation wirings 13 of the second embodiment are in contact with the spacer 7. Thus, the potential also varies periodically as shown in FIG. 9B by being affected by the potential of the modulation wirings 13. However, the broken line shown in FIG. 9B indicating the center of the periodical potential variation shows that a potential gradient is formed in the longitudinal direction of the spacer 7. The present invention also encompasses such a structure.

In the second embodiment, the conductive member 22 is formed at a position nearer to the metal back 4 than the rear plate-side end surface of the spacer 7. Thus, the potential to be applied to the conductive member 22 is higher than that in the first embodiment. In other words, as the position where the conductive member 22 is to be formed shifts in the Z direction, the potential to be applied to the conductive member 22 increases.

### EXAMPLES

### Example 1

In this example, examples of a method for making a spacer including a conductive member and a method for adjusting the electron-irradiated position are described in detail.

### Step 1: Spacer Base Member

Glass having good mechanical strength and electrical insulation was used as the spacer base member. The glass that served as a base material was stretched under heating to obtain a long plate-shaped spacer base member.

### Step 2: Formation of High-Resistance Film

A nitride of an alloy of germanium and tungsten was deposited on a surface of the spacer base member prepared in Step 1 to form a high-resistance film. The thickness of the high-resistance film was 100 nm and the sheet resistance was about 1×10¹¹Ω/□.

### Step 3: Formation of Conductive Member

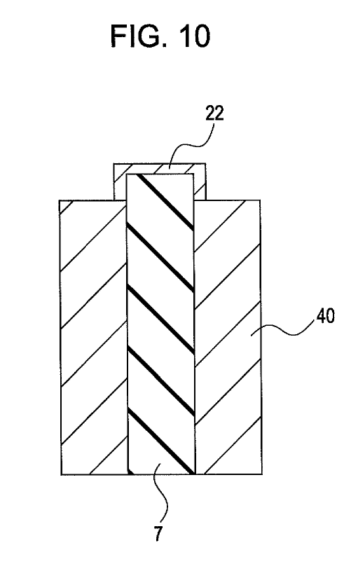

A conductive member 22 composed of Cu was formed on the spacer with the high-resistance film formed thereon prepared in Step 2. In order to form the conductive member 22 on the rear plate-side end surface of the spacer 7, the spacer 7 was first inserted into a deposition jig 40 as shown in FIG. 10. Then copper was deposited by sputtering while having the spacer 7 protrude from the deposition jig 40 by a particular height. The sheet resistance of the deposited Cu film was about 1×10³Ω/□.

Step 4: Fixing the Spacer and Supplying Power to the Conductive Member

The spacer 7 prepared in Step 3 was fixed on the rear plate 8. A conductive adhesive containing a Ag filler and a ceramic powder dispersed in liquid glass was used for fixing. Wirings (not shown) were formed on portions of the rear plate 8 which were outside the image display region and were to be bonded to the spacer 7 so that power can be supplied from the potential supplying units 23 and 24, i.e., an external power source. The portion within the image display region where the rear plate 8 contacted the spacer 7 was insulated by providing the insulating layer 20 on the rear plate 8.

### Step 5: Measuring the Electron-Irradiated Positions and Supplying Power to the Conductive Member

The spacer 7, the rear plate 8, and the face plate 1 prepared as such were used to form an image display apparatus. First, the power was supplied to the conductive member 22 while adjusting the potential supplying units 23 and 24 to 10 V to allow the image display apparatus to display images. The positions on the face plate 1 irradiated with electrons were then photographed using a camera for measuring the electron-irradiated positions. The measurement results are shown in FIG. 6. The electron-irradiated positions near the spacer were shifted toward the spacer 7 at the potential supplying unit 23 side (FIG. 6, part (a)) and shifted away from the spacer 7 at the potential supplying unit 24 side (FIG. 6, part (c)). Then 8 V was applied from the potential supplying unit 23 and 12 V was applied from the potential supplying unit 24 to the conductive member 22 to form a potential gradient in the conductive member 22 in the longitudinal direction of the spacer 7. As a result, L1 increased while L2 decreased, thereby decreasing the difference between L1 and L2. As a result, the image quality of the image display apparatus improved.

### Example 2

In this example, as shown in FIG. 8, the conductive member 22 was formed on a side surface of the spacer 7 instead of the rear plate-side end surface of the spacer 7. Other structures are identical to those of the first embodiment and detailed description therefor is omitted.

Steps 1 and 2 were the same as in EXAMPLE 1.

### Step 3: Formation of Conductive Member

A solution containing dispersed fine particles of tin oxide was ejected by an ink jet technique on a side surface of the spacer having the high-resistance film thereon prepared in Step 2 to form a conductive member.

### Step 4: Fixing the Spacer and Supplying Power to the Conductive Member

The spacer 7 prepared in Step 3 was fixed on the rear plate 8. A conductive adhesive containing a Ag filler and a ceramic powder dispersed in liquid glass was used for fixing. Wirings (not shown) were formed on portions of the rear plate 8 which were outside the image display region and were to be bonded to the spacer 7 so that power can be supplied from the potential supplying units 23 and 24, i.e., an external power source, to the conductive member 22.

### Step 5: Measuring the Electron-Irradiated Positions and Supplying Power to the Conductive Member

The spacer 7, the rear plate 8, and the face plate 1 prepared as such were used to form an image display apparatus. First, the power was supplied to the conductive member 22 while adjusting the potential supplying units 23 and 24 to 400 V to allow the image display apparatus to display images. The positions on the face plate 1 irradiated with electrons were then photographed using a camera for measuring the electron-irradiated positions. The measurement results of this example are shown in FIG. 6. The electron-irradiated positions near the spacer were shifted toward the spacer 7 at the potential supplying unit 23 side (FIG. 6, part (a)) and shifted away from the spacer 7 at the potential supplying unit 24 side (FIG. 6, part (c)). Then 400 V was applied from the potential supplying unit 23 and 600V was applied from the potential supplying unit 24 to the conductive member 22 to form a potential gradient in the conductive member 22 in the longitudinal direction of the spacer 7. As a result, L1 increased while L2 decreased, thereby decreasing the difference between L1 and L2. As a result, the image quality of the image display apparatus improved.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-298179, filed Nov. 21, 2008, which is hereby incorporated by reference herein in its entirety.

What is claimed is:

1. An image display apparatus comprising:
a rear plate including a plurality of electron-emitting devices;
a face plate including an anode electrode configured to accelerate electrons emitted from the plurality of electron-emitting devices;
a spacer which is a plate-shaped spacer disposed between the rear plate and the face plate, the spacer including a conductive member formed in a longitudinal direction of the spacer; and
a potential-supplying unit configured to form a potential gradient in the conductive member in the longitudinal direction of the spacer so as to compensate a difference between a distance to the spacer from a position on the face plate irradiated with electrons emitted from a first electron-emitting device among the plurality of electron-emitting devices and a distance to the spacer from a position on the face plate irradiated with electrons emitted from a second electron-emitting device among the plurality of electron-emitting devices, the second electron-emitting device being located at a position shifted in the longitudinal direction of the spacer with respect to a position of the first electron-emitting device.

2. The image display apparatus according to claim 1, wherein the conductive member is disposed on a surface of the spacer, the surface facing the rear plate.

3. The image display apparatus according to claim 1, wherein the spacer is arranged to extend across an image display region in the longitudinal direction of the spacer.
